(19) United States
(12) Patent Application Publication
(10) Pub. No.: US 2009/0039103 A1
(43) Pub. Date: Feb. 12, 2009

(54) Optical disc dispenser for printer or duplicator

(75) Inventors: Bogdan Sobonski, West Islip, NY (US); Jerzy Stypulkowski, West Babylon, NY (US)

Correspondence Address: BODNER & O'ROURKE, LLP, 425 BROADHOLLOW ROAD, SUITE 108, MELVILLE, NY, 11747, US

(73) Assignee: Yurex, Inc., Holbrook, NY (US)

(21) Appl. No.: 12/228,025

(22) Filed: Aug. 8, 2008

Related U.S. Application Data
(60) Provisional application No. 60/964,266, filed on Aug. 10, 2007.

(51) Int. Cl. B65G 59/00

(52) U.S. Cl. 221/292; 221/290

(57) ABSTRACT

An optical disc dispenser includes a base and a top cover with an opening for a stack of optical discs. The diameter of the opening is larger than the diameter of a disc so the discs can pass through the opening freely. The disc dispenser also includes two or more support gate elements, which in idle state, support the disc stack. These support gate elements, which form a support gate, can move. As a result of such movement of the support gate elements, their collective surface can create an opening larger or smaller than the size of a handled disc. The disc dispenser also includes synchronized separator fingers and a recess which is located on a height of the second disc from the bottom of the stack.

### CROSS-REFERENCE TO RELATED APPLICATION

This application is based on U.S. Provisional Application No. 60/964,266, filed on Aug. 10, 2007, and entitled, “Optical Disc Dispenser for Printer or Duplicator”, the disclosure of which is incorporated herein by reference and on which priority is hereby claimed.

### BACKGROUND OF THE INVENTION

1. Field of the Invention

The present invention relates to mechanisms for transferring optical discs from one location to another location, and more specifically relates to optical disc dispensers for use with disc printers, disc duplicators, disc shredders, disc counters and other devices.

2. Description of the Prior Art

The invention of CD (compact disc) recordable technology triggered a real revolution in the mass storage industry. Within a short period of time, floppy disk drives were replaced with CD-R devices. “Read Only” discs, such as a CD-ROM or a DVD-ROM, are a perfect solution for high volume music, movies, or software releases. The invention of recordable technology created a natural need for CD printing technology.

Initially, optical disc printers were designed as manual devices, but quickly they were embraced by the CD/DVD duplication industry for low and medium volume production. Typically, disk printers have a sliding tray on which the blank disc is placed. The tray with the disc then moves inside the unit. Then, the printing process starts. After successful printing, the tray opens and the disc is available for further handling. It is also natural that this type of printer is automated by an add-on robot.

The robot typically has a rotating arm with a disc picking mechanism. Discs are held on one or more stacks. The robot picks a disc from the stack and places it on the printer or recording drive tray. After the disc is recorded or printed, the tray is opened, allowing the robot to take it back and put it on the output stack. The drawback of such system is the large size of the mechanism and the low speed of loading.

Such conventional devices have been designed and sold on the market. They proved to be difficult to design and manufacture. The price of such printers is high, and this limits their use to the optical disc duplication industry.

### OBJECTS AND SUMMARY OF THE INVENTION

It is an object of the present invention to provide an optical disc dispenser for use with a disc printer, disc duplicator, disc shredder, disc counter or other device.

It is another object of the present invention to provide an optical disc dispenser which is extremely reliable and inexpensive to manufacture.

It is still another object of the present invention to provide an optical disc dispenser for use with a disc printer, disc duplicator and other devices which exhibits a relatively high disc loading speed.

It is a further object of the present invention to provide an optical disc dispenser which is compact in size.

It is still a further object of the present invention to provide an optical disc dispenser which overcomes the inherent disadvantages of known optical disc dispensers.

A system for printing or duplicating optical discs (such as CD, DVD, Blue Ray, HD-DVD and others) uses an optical disc dispenser, which dispenses discs from a stack. The system has the dispenser typically mounted above a recording or printing device tray, or a conveyor belt. The disc dispenser includes a base and a top cover with an opening for a stack of discs. The diameter of the opening is larger than the diameter of a disc so the discs can pass through the opening freely. The disc dispenser also includes two or more support gate elements, which in idle state, support the disc stack. These support gate elements, which form a support gate, can move. As a result of such movement, their collective surface can create an opening larger or smaller than the size of a handled disc. The disc dispenser also includes synchronized separator fingers and a recess which is located on a height of the second disc from the bottom of the stack. The first disc from the bottom always remains axially aligned with the disc stack, with exception of the second disc from the bottom. One of the separator fingers pushes the second from the bottom disc into this recess. The separator finger and this particular disc, which is axially offset from the axis of the stack, support the stack above it. In the next stage, the support gate is opened, allowing the first disc from the bottom of the stack to fall. The support gate closes and the next disc is pushed out of the disc holding recess so it is again aligned axially with the disc stack above it. As it reaches this alignment, this disc falls with the rest of the discs in the stack onto the support gate. The dispenser is then ready to perform another cycle. Although the optical disc dispenser is primarily described herein as being used with a disc printer, it is envisioned to be within the scope of the present invention to use the optical disc dispenser with disc duplicators, disc shredders, disc counters and other devices.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a view of the automated disc printer utilizing the disc dispenser which is a subject of the present invention.

FIG. 2 is a perspective view of the disc feeding mechanism of the disc dispenser of the present invention.

FIG. 3 is a perspective view of the disc dispenser module used in the present invention.

FIG. 4 is an exploded view of the disc dispenser of the present invention.

FIG. 5 is a perspective view of the dispenser base with motor and sensor board of the disc dispenser of the present invention.

FIG. 6 is perspective view of the dispenser base with movable guide ring of the disc dispenser of the present invention.

FIG. 7 is a perspective top view of the dispenser base with motor and mounted sensor board of the disc dispenser of the present invention.

FIG. 8 is a bottom view of the dispenser base with motor, mounted sensor board, sensor flag and a support gate guiding cutouts of the disc dispenser of the present invention.

FIG. 9 is a top view the top view of the dispenser base with motor and drive gears of the disc dispenser of the present invention, and illustrating the limits of the movement of the guide ring.

FIG. 10 is a side view of the dispenser base with mounted motor, sensor flag and sensor board of the disc dispenser of the present invention.

FIG. 11 is a perspective view of the dispenser base, support gate elements and their guide pins of the disc dispenser of the present invention.

FIG. 12 is a perspective view of the dispenser base and inserted support gate elements of the disc dispenser of the present invention.

FIG. 13 is a perspective view of the dispenser base with inserted support gate elements and separator bed with separator recess of the disc dispenser of the present invention.

FIG. 14 is a perspective view of the dispenser base, support gate elements, separator bed and separator fingers of the disc dispenser of the present invention.

FIG. 15 is a top view of the dispenser base, support gate elements, separator bed and separator fingers of the disc dispenser of the present invention.

FIG. 16 is a partial cross-sectional view of the disc dispenser of the present invention with a stack of discs in the idle state.

FIG. 17 is a top view of the disc dispenser of the present invention with the second from the bottom disc moved into the separator recess.

FIG. 18 is a partial cross-sectional view of the disc dispenser of the present invention with the second from the bottom disc moved into the separator recess.

FIG. 19 is a top view of the disc dispenser of the present invention with the second from the bottom disc moved into the separator recess and the support gate open, whereby the first disc from the bottom is released.

FIG. 20 is a partial cross-sectional view of the disc dispenser of the present invention with the second disc from the disc stack bottom inserted into the separator recess and the support gate open, whereby the first disc from the bottom is released.

FIG. 21 is a top view of the disc dispenser of the present invention after full cycle of separation is completed.

FIG. 22 is a partial cross-sectional view of the disc dispenser of the present invention with the stack of discs in the idle state after full cycle of separation is completed, the stack of discs having one less disc than the stack of discs shown in FIG. 16.

### DETAILED DESCRIPTION OF THE PREFERRED EMBODIMENTS

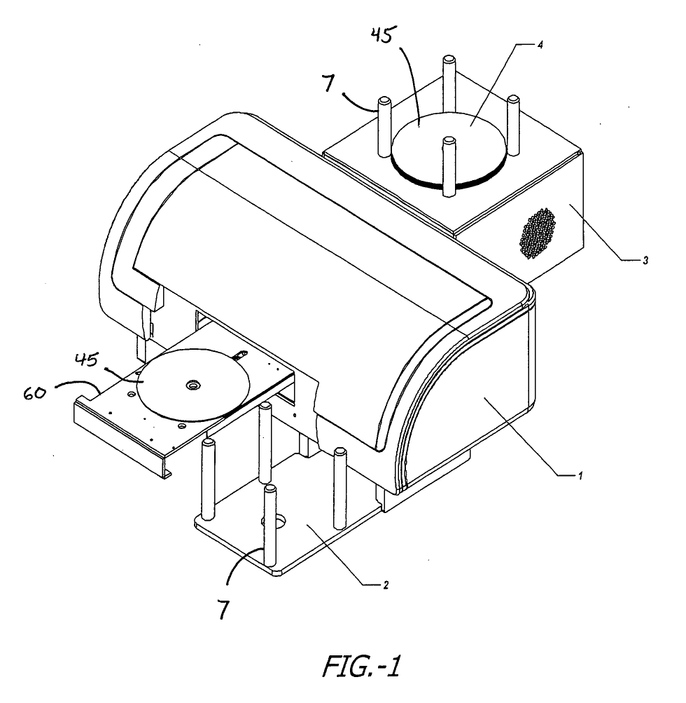

FIG. 1 shows the printer with the input disc bin 4 and the output disc bin 2 attached to the main body of the printer 1. The discs 45 are placed into the input bin 4. The input bin 4 includes a disc feeding assembly 3. The bottom disc from the stack is dropped, it is printed (or duplicated), and then ejected from the printer or duplicator tray 60 to the output bin 2. The upstanding disc holder rods 7 on the input disc bin 4 and the output disc bin 2 are spaced apart from one another and positioned about the circumference of the discs 45 to maintain the discs in a particular position on the bins 2, 4 and in a stacked arrangement.

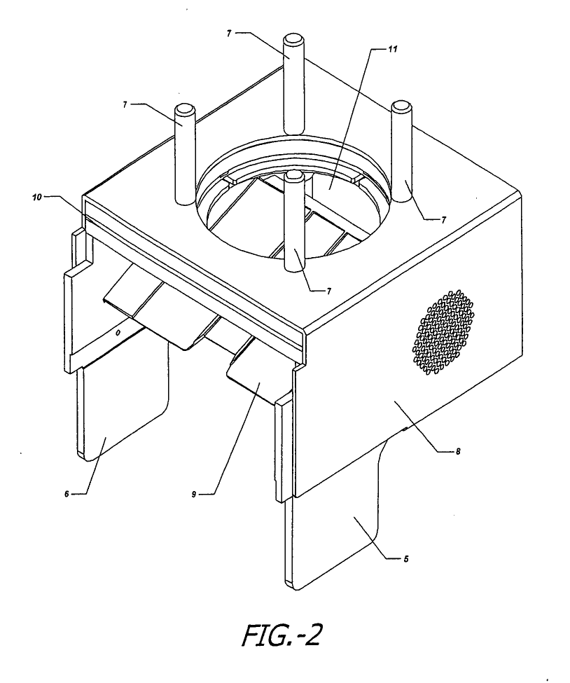

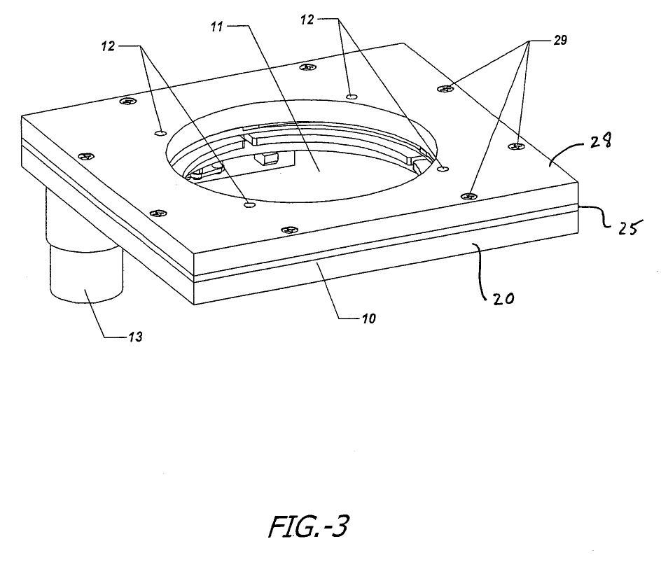

FIG. 2 shows the disc feeding assembly 3 of the present invention. It is comprised of the disc dispenser 10, two side walls 5 and 6 for mounting the disc feeding assembly 3 above a printer or duplicator movable tray or conveyor belt, ramp or sliding surface 9 positioned below and inclined from the disc dispenser 10, a cover 8 mounted above the disc dispenser 10 and having an opening 62 aligned with the opening 11 (see FIG. 3) of the dispenser assembly and four disc holder rods 7 mounted on and extending perpendicularly from the outer surface of cover 8. After the disc from the bottom of the dispenser 10 is dropped, it slides on the sliding surface 9 to a desired position on the printer or duplicator tray 60. More specifically, a stack of optical discs 45 are placed within the perimeter defined by the upstanding disc holder rods 7 situated on the input disc bin 4. One by one the discs 45 are dispensed by the optical disc dispenser 10 onto the inclined sliding surface 9 so that they are sequentially received by the printer or duplicator tray 60 (or conveyor belt) of the optical disc printer or duplicator. The printer or duplicator tray 60 (or conveyor belt) moves the optical disc 45 which it receives into a position for printing or duplicating. When the printing or duplication operation is completed, the printer or duplicator tray 60 or conveyor belt of the printer or duplicator then moves the optical disc 45 to a position where it is dislodged from the printer or duplicator tray 60 or conveyor belt onto the output disc bin 2 within the periphery defined by the disc holder rods 7 mounted on output disc bin 2 to form a stack of printed or duplicated optical discs for removal therefrom.

FIG. 3 shows the dispenser assembly of the present invention. It has an opening 11 formed through its thickness through which the discs move. The driving element is preferably a DC motor 13. The top part of the dispenser assembly has screws 12 which allow mounting of the input bin disc holders 7 shown in FIG. 2.

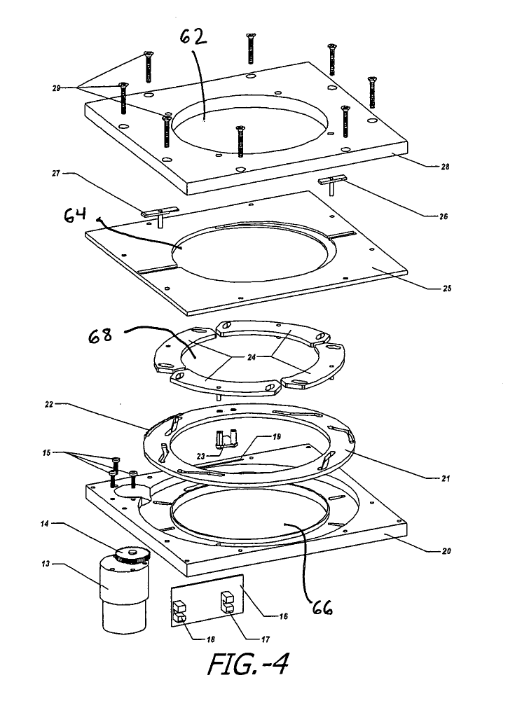

FIG. 4 is an exploded view of the disc dispenser assembly 10. The disc dispenser assembly preferably includes a DC motor 13 with a gear 14 mounted on its shaft. The motor 13 is attached axially perpendicularly to a generally planar dispenser base 20 with screws 15 passing through the thickness of base 20 and into motor 13. A gear (toothed) rack 22 is formed on an arcuate portion of the peripheral edge of a guide ring 21 which is rotatably mounted on dispenser base 20, as can be seen in FIG. 4. A sensor flag 23 is also attached to the guide ring 21. One or more (preferably four) support gate elements 24 arranged circularly end-to-end are placed between the guide ring 21 and a generally planar separator plate 25. A pair of separator fingers 26 and 27 (that is, an eject separator finger 26 and an insert separator finger 27) are placed between the separator plate 25 and a generally planar top cover plate 28 of the disc dispenser assembly. The dispenser base 20, the separator plate 25 and the top cover plate 28 are held together with screws 29 received in countersunk holes formed in the top cover plate 28, holes formed through the thickness of separator plate 25 and threaded holes formed in dispenser base 20. Each of the top cover plate 28, the separator plate 25 and the base 20 has an opening 62, 64 and 66, respectively, which are in alignment with each other and generally define the dispenser opening 11.

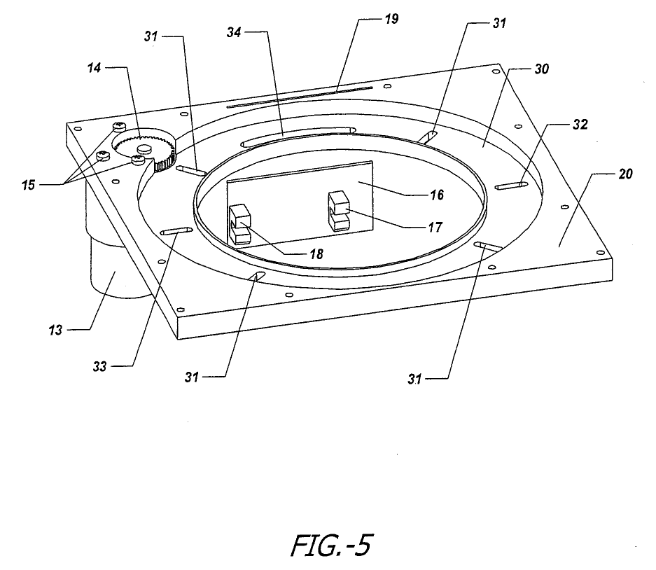

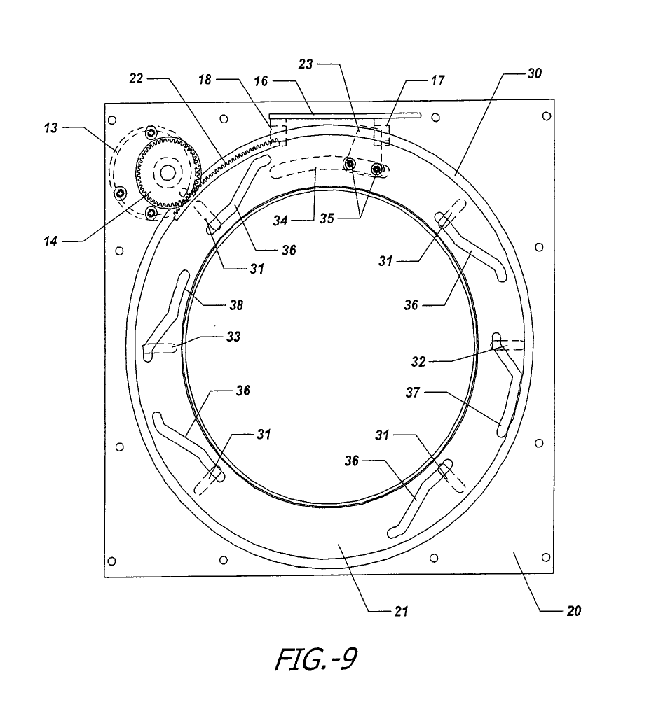

FIG. 5 shows how the DC motor 13 with gear 14 is mounted to the dispenser base 20. The dispenser has a guide ring bed 30 formed as a circular recess in the top surface of dispenser base 20, and spaced apart radial cutouts 31 formed in the guide ring bed 30 for receiving support gate element pins 39 which extend perpendicularly from the bottom surface of each support gate element 24 and situated centrally longitudinally thereon. A pair of diametrically opposed radial cutouts 32, 33 are also formed in the base 20 and situated within guide ring bed 30. Cutouts 32, 33 receive and allow to reciprocatingly move therein the free ends of pins 40, 43 extending perpendicularly from the lower surface of two separator fingers 26, 27, respectively. A partially circular (arcuate) cutout 34 also formed in the bed 30 allows a sensor flag 23 to move between sensors 17 and 18 which are mounted to a printed circuit board 16 (see FIG. 9). Sensors 17 and 18 are preferably optical sensors, each having a light source and a light detector, the sensor flag 23 being selectively movable between the light source and light detector of each sensor 17, 18 to break the light path of each sensor. A cutout 19 formed through the thickness of base 20 is made for mounting the circuit board 16 with the sensors 17, 18. Although optical sensors 17,18 are described herein to limit the rotation of the guide ring 21, it is envisioned to be within the scope of the present invention to use other guide ring rotation limiting means, such as limit switches in place of optical sensors 17 and 18, or mechanical stops.

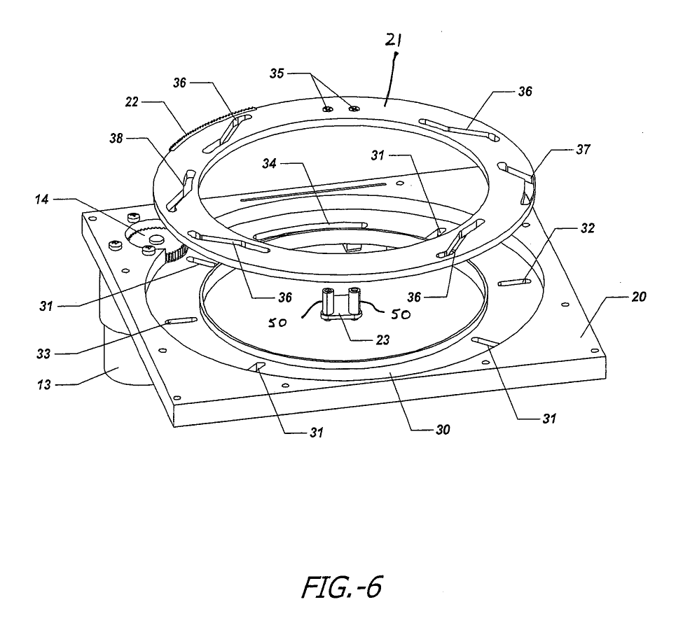

FIG. 6 shows in a partially exploded, perspective view the disc dispenser base 20 with the guide ring 21. The sensor flag 23 slides within the arced cutout 34. The sensor flag 23 is permanently attached to the guide ring with screws placed in the holes 35 which are received by threaded posts 50 of sensor flag 23, which posts 50 move reciprocatingly in cutout 34.

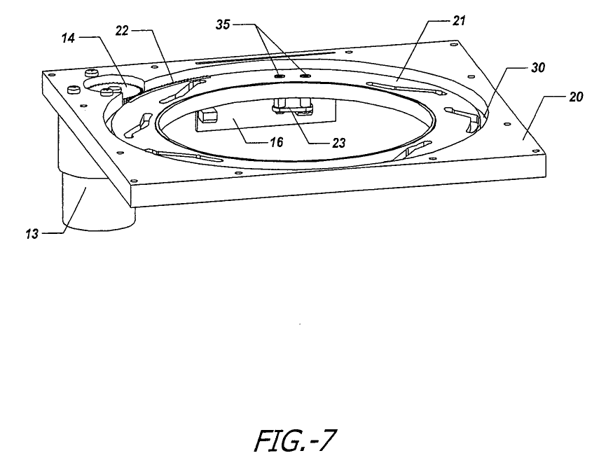

FIG. 7 is a perspective view of the dispenser base 20 with the guide ring 21 mounted thereon. A gear rack 22 is attached to or formed in the periphery of the guide ring 21. The guide ring with the gear rack 22 is rotated by the gear 14 mounted on the shaft of the motor 13 engaging the rack 22. The guide ring 21 can move within an arc defined by the two sensors 17, 18 mounted to the sensor board 16 (See FIG. 5). The sensor flag 23 selectively interrupts the light path of each sensor 17, 18, which provides electrical signals to an electronic controller (not shown) so that the electronic controller knows the state of the mechanism and when to start and finish turning the motor 13.

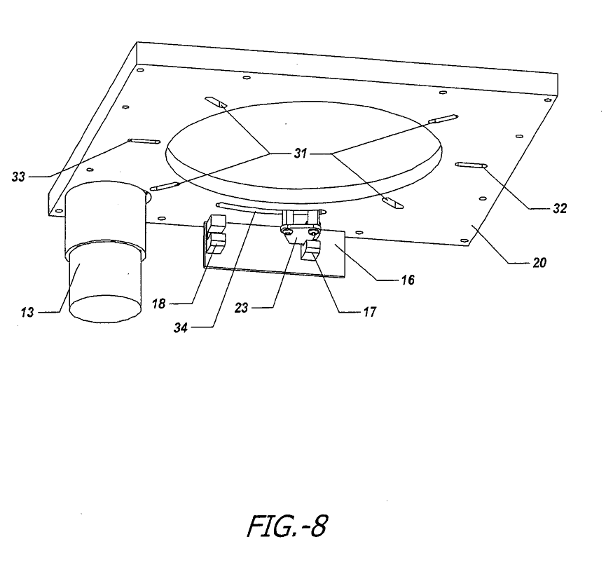

FIG. 8 is a perspective view of the underside of the dispenser base 20 with the sensors 17 and 18 mounted to the board 16. The sensor flag 23 can only move angularly within the cutout 34 between the sensors 17 and 18.

FIG. 9 is a top view of the dispenser base 20 with the guide ring 21 placed in its bed 30 and at least partially rotatable in the bed in clockwise and counterclockwise directions in response to the rotation of motor gear 14 and its engagement with rack 22.

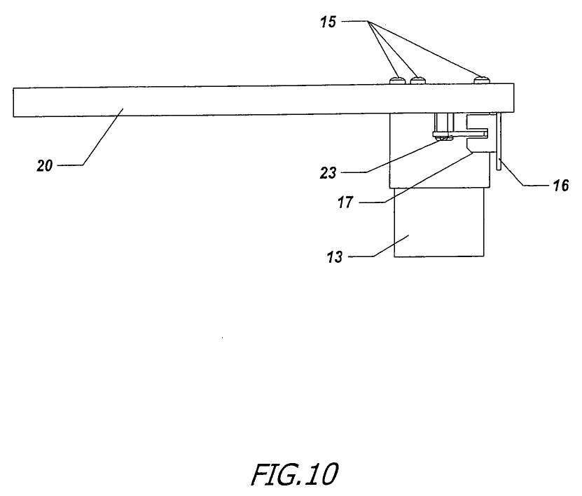

FIG. 10 is a side view of the dispenser base 20, motor 13, sensor flag 23 and sensor board 16. It shows how the sensor flag 23 is capable of selectively interrupting the light path of the sensors 17, 18.

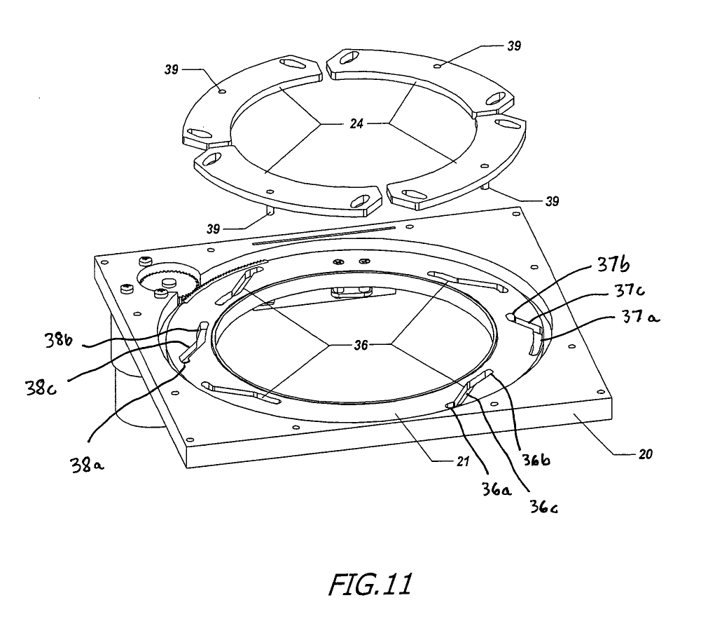

FIG. 11 shows how the support gate elements 24, with permanently attached pins 39, are placed above the guide ring 21. The support gate element pins 39 can move within corresponding cutouts 36 formed in the upper surface or through the thickness of guide ring 21. Each cutout 36 includes three interconnected segments—a first outer, arcuate segment 36a disposed radially outwardly on guide ring 21, a second inner, arcuate segment 36b disposed radially inwardly on guide ring 21, and an intermediate third segment 36c which extends transversely between and is in communication with the first outer segment 36a and the second inner segment 36b. As the guide ring 21 rotates in a clockwise or counterclockwise direction, the pins 39 of each support gate element 24 move within and follow the curvature of their corresponding cutout 36. Since the pins 39 of the support gate elements 24 are also received by and confined to move within the radial cutouts 31 formed in the dispenser base 20, the support gate elements 24 are caused to move in unison radially inwardly and outwardly of base 20 and central dispenser opening 11 when the guide ring 21 is rotated.

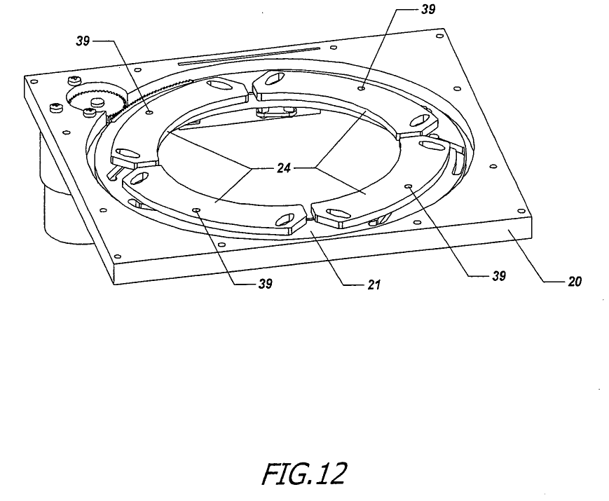

FIG. 12 shows how the support gate elements 24 rest on the guide ring 21.

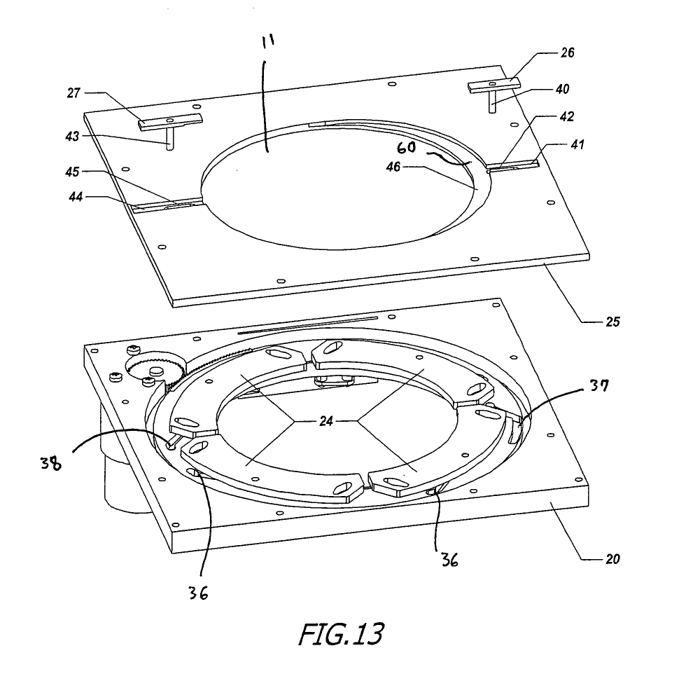

FIG. 13 shows the separator plate 25 with the separator fingers 26 and 27. The separator plate has formed in the upper surface thereof an arcuate recess 46 to define a recessed disc holding lip 60. The depth of this recess 46 is preferably the same as or is close to the thickness of an optical disc to allow inserting a single optical disc within recess 46 so that an arcuate edge portion of the disc may rest on holding lip 60. The separator fingers 26 and 27 both have permanently attached pins 40 and 43, respectively. The separator finger 27 can slide within a track or recess 44 formed in the upper surface of the separator plate 25 and extending radially with respect to opening 11, and its guiding pin 43 can slide within a cutout 45 formed in the recessed surface of the separator plate 25 and extending within and partially along the length of recess 44. The separator finger 26 can slide within a track or recess 41 formed in the upper surface of the separator plate 25 and extending radially with respect to opening 11 and situated diametrically opposite from recess 44, and its guiding pin 40 can slide within a cutout 42 formed in the recessed surface of the separator plate 25 and extending within and partially along the length of recess 41. The thickness of the separator fingers 26 and 27 is the same as or very close to the thickness of an optical disc.

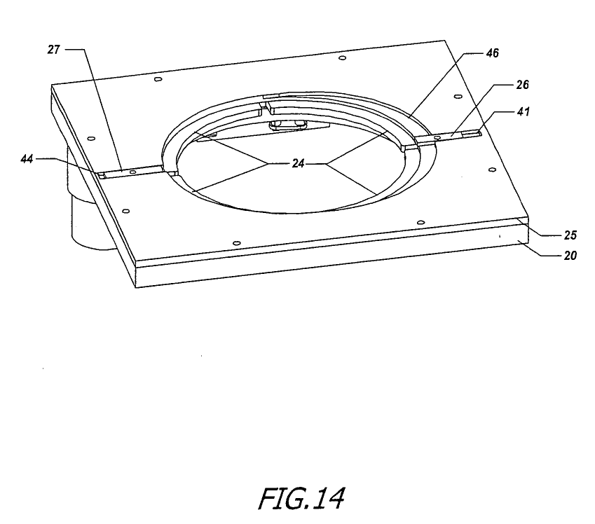

FIG. 14 shows how the separator plate 25 rests on top of the disc dispenser base 20. The insert separator finger 27 slides in the recess 44. The eject separator 26 slides in the recess 41. The movement of the two separator fingers 26 and 27 is synchronized because their guide pins 40 and 43 slide within the cutouts 38 and 37, respectively, of the guide ring 21 shown in FIG. 13.

Like cutouts 36, each cutout 37, 38 includes three interconnected segments—a first outer, arcuate segment 37a, 38a disposed radially outwardly on guide ring 21, a second inner, arcuate segment 37a, 38b disposed radially inwardly on guide ring 21, and an intermediate third segment 37c, 38c which extends transversely between and is in communication with the first outer segment 37a, 38a and the second inner segment 37a, 38b. As the guide ring 21 rotates in a clockwise or counterclockwise direction, the pins 40, 43 of the separator fingers 26, 27 move within and follow the curvature of their corresponding cutout 37, 38. Since the pins 40, 43 of the separator fingers 26, 27 are also received by and confined to move within radial cutouts 42, 45, and because the separator fingers 26, 27 are confined to move within radial recesses 41, 44 formed in the separator plate 25, and further because the free ends of pins 40, 43 are received by and confined to move within the radial cutouts 32, 33 formed in the dispenser base 20, the separator fingers 26, 27 are caused to move in opposite directions radially inwardly and outwardly of base 20 and central dispenser opening 11 when the guide ring 21 is rotated.

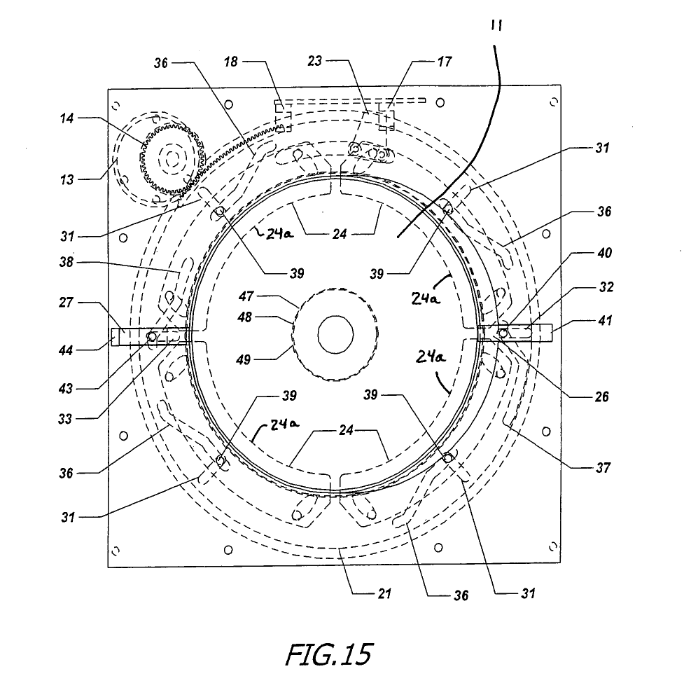

FIG. 15 shows the idle position of the separator fingers 26 and 27 as well as the support gate elements 24. In the idle state, the guide ring 21 rests in a position where the sensor flag 23 interrupts or blocks the optical path of sensor 17. The insert separator finger 27 rests in the most radially outer position within the recess 44 of the separator plate 25. The eject separator finger 26 rests in the most radially inner position within the recess 41 so that it extends over the disc holding recess 46. The support gate elements 24 do not allow the stacked discs to drop, as their most radially inner edge 24a extend within opening 11 and thus define a circular gate opening 68 which has a diameter that is less than that of opening 11.

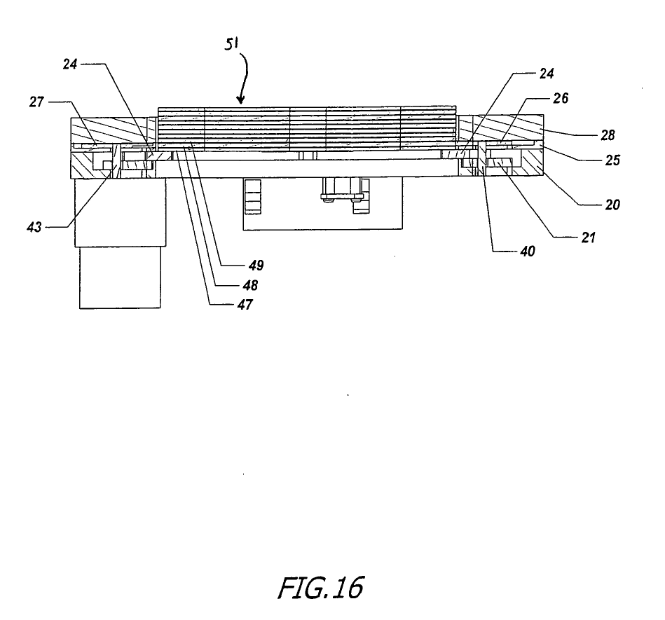

FIG. 16 is a side cross-sectional view of the disc dispenser in the idle state with a stack 51 of optical discs situated thereon. The optical discs rest on the support gate elements 24. The insert separator finger 27 and eject separator finger 26 stay out of the line of the stack of the discs and do not engage any of the discs.

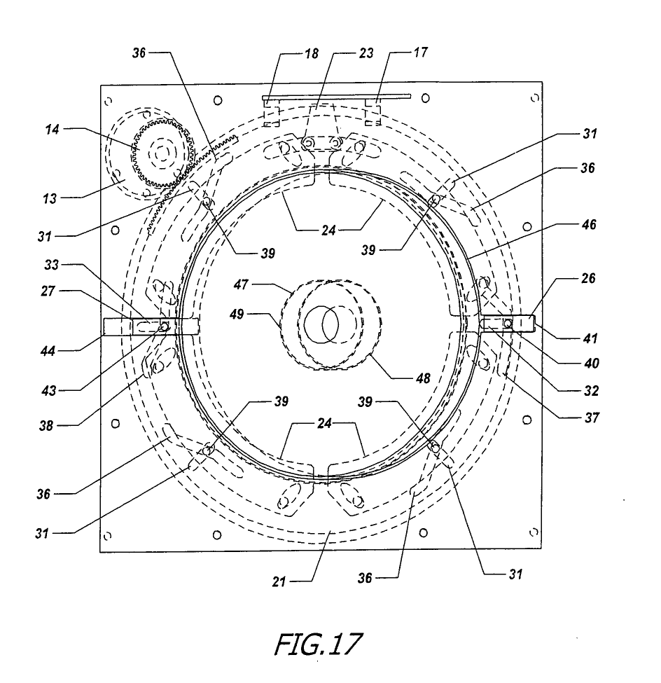

FIG. 17 is a top view of the disc dispenser assembly and its parts in the state when second disc 48 from the bottom of the stack 51 is pushed into the disc holding recess 46. In order to get to this state, the guide ring 21 was rotated (counterclockwise when viewing FIG. 17) by DC motor 13 with gear 14. The sensor flag 23 moved to a position between sensors 17 and 18. Eject separator finger 26 moved radially outwardly within the recess 41. The insert separator finger 27 moved radially inwardly within the recess 44 towards the center of the disc stack 51 which caused the second disc 48 from the bottom of stack 51 to be pushed into the recess 46 to rest on lip 60. Both separator fingers 26 and 27 were moved because their guiding pins 40 and 43 are constrained by the cutouts 38 and 37 in the guide ring 21, which was rotated, and by radial cutouts 42, 45 formed in the separator plate 25 and radial cutouts 32, 33 formed in the dispenser base 20. The support gate elements 24 did not change their position because the shape of the cutouts 36 did not force the support gate element guiding pins 39 to move.

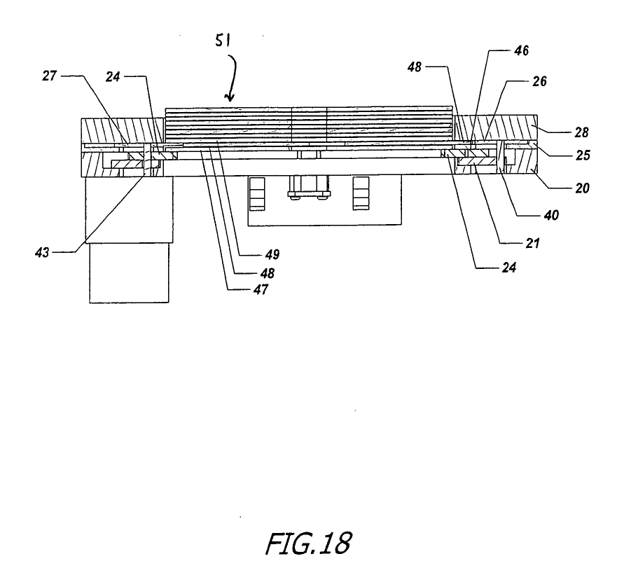

FIG. 18 is a side cross-sectional view of the disc dispenser, which corresponds to that which is shown in FIG. 17. The most bottom disc 47 in the stack 51 is resting on the support gate elements 24 and it is aligned with the stack 51 of discs above the second disc 48 from the bottom of the stack 51. The second disc 48 from the bottom is displaced laterally from the stack 51 into the disc holding recess 46 so that the edge of the disc 48 rests on lip 60. The weight of the third disc 49 from the bottom of the stack 51 and those discs in the stack 51 above the second disc 48 from the bottom rests on the second disc 48 and the insert separator finger 27.

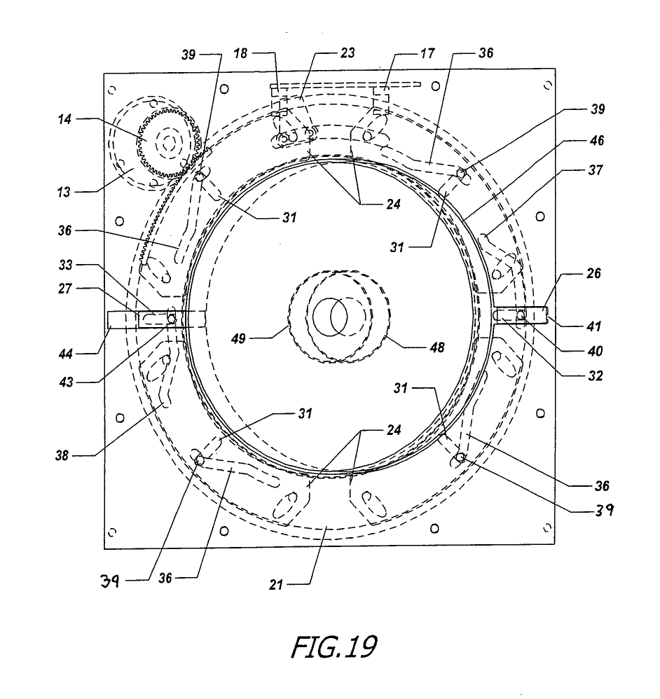

FIG. 19 is a top view of the disc dispenser and its parts in the state when the second disc 48 from the bottom of the stack 51 is in the disc holding recess 46 and resting on lip 60, and the support gate elements 24 are moved out of the way of the most bottom disc 47, allowing it to drop with the help of the force of gravity. The guide ring 21 is in the position where the optical path of sensor 18 is blocked by sensor flag 23. The cutouts 36 forced the guiding pins 39 and consequently the support gate elements 24 to move in a radially outwardly direction from the center of the disc stack 51. The separator fingers 26 and 27 remained in an unchanged position because of the shape of the guiding cutouts 38, 37.

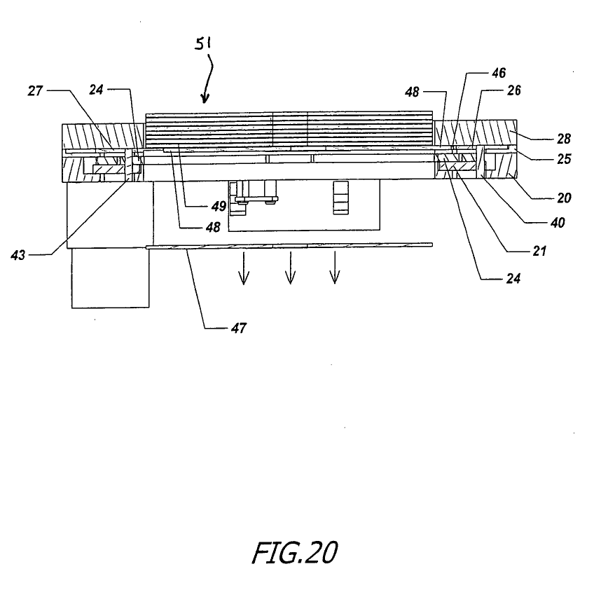

FIG. 20 is a side cross-sectional view of the disc dispenser, which corresponds to that which is shown in FIG. 19. The support gate elements 24 are moved out of the way to define a gate opening 68 which is equal to or greater than the diameters of the separator plate opening 64 and the optical discs so that the most bottom disc 47 from the stack 51 may drop (shown by arrows) through gate opening 68 due to the force of gravity. The next disc 48 from the bottom of the stack 51 is located in the disc holding recess 46 to rest on lip 60 and it is offset from the stack. The weight of the remaining discs is resting on the disc 48 and the separator finger 27.

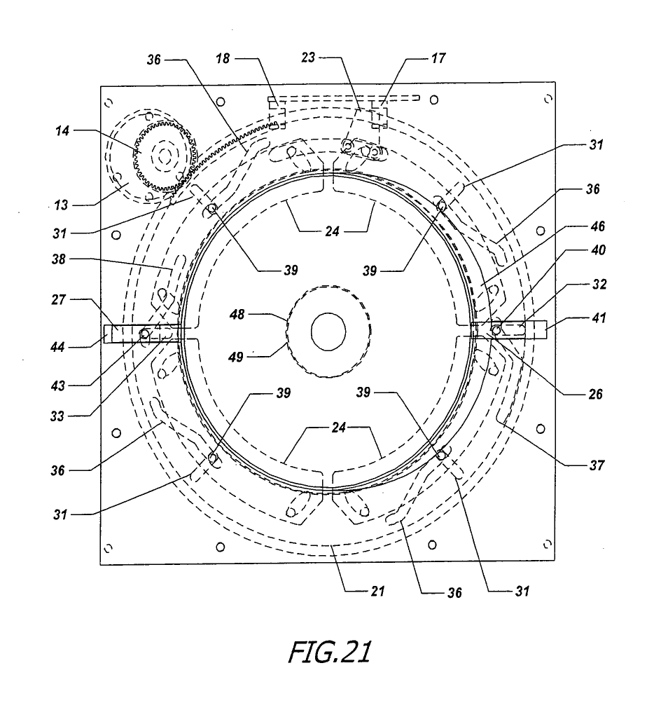

FIG. 21 shows a top view of the disc dispenser and its parts in the last stage of the disc dispensing cycle. The guide ring 21 is rotated back (clockwise when viewing FIG. 21) so the sensor flag 23 blocks the optical path of sensor 17. During the movement of the guide ring 21 between sensor 18 and sensor 17, first the support gate elements 24 are pushed out radially to their idle position. They form an opening having a diameter that is smaller than the diameter of the optical discs and opening 11. After this happens, the separator finger 27 is moved radially outwardly within the recess 44 and simultaneously the separator finger 26 is moved radially inwardly within the recess 41. The result is that the disc 48, along with the rest of the discs in the stack 51, drops onto the support gate elements 24 and are supported thereby.

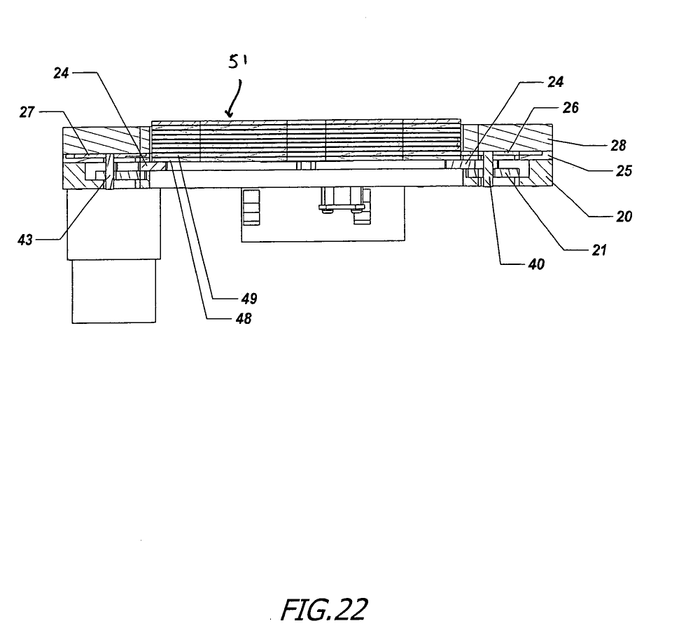

FIG. 22 is a side cross-sectional view of the disc dispenser, which corresponds to that which is shown in FIG. 21. The disc 48 is now on the bottom of the stack 51. It rests with the rest of the stack on the support gate elements 24. The disc dispenser is ready to perform another cycle.

The invention disclosed herein is an efficient way to dispense the disks for printing and the like. The invention is extremely reliable and, at the same time, inexpensive to manufacture. The present invention significantly reduces the loading time because it takes a very short time to drop one disc from the bottom of the stack onto the printer tray.

The optical disc dispenser of the present invention is useable with a number of devices including, but not limited to, disc printers, disc duplicators, disc shredders and disc counters.

Although illustrative embodiments of the present invention have been described herein with reference to the accompanying drawing, it is to be understood that the invention is not limited to those precise embodiments, and that various other changes and modifications may be effected therein by one skilled in the art without departing from the scope or spirit of the invention. For example, it is envisioned that only one separator finger 26 or 27 be used to move an optical disc 45 in the stack 51 onto or away from the disc holding lip 60 and into or out of recess 46. Also, for example, it is envisioned that one disc support gate element 24 is used in the dispenser, or a pair of support gate elements 24 are used which are positioned opposite one another on diametrically opposite sides of the separator plate opening 64 to define a space therebetween, the space having a first dimension which is greater than or equal to the diameter of the separator plate opening 64 when the support gate elements 24 are in a first position to allow an optical disc 45 to pass through the space between the support gate elements, and having a second dimension which is less than the diameter of the separator plate opening 64 when the support gate elements are in a second position to prevent an optical disc 45 from passing through the space between the support gate elements 24.

What is claimed is:

1. An optical disc dispenser for holding a stack of optical discs and selectively dispensing therefrom an optical disc, which comprises:
a separator plate, the separator plate having a separator plate opening formed through the thickness thereof and having a predetermined diameter to allow an optical disc to pass therethrough, the separator plate having an arcuate recess formed therein and adjacent to the separator plate opening to define a recessed disc holding lip;
a guide ring situated below the separator plate, the guide ring being rotatable relative to the separator plate;
at least one support gate element, the at least one support gate element being mounted on the guide ring and movable radially thereon in response to rotation of the guide ring; and
at least one separator finger, the at least one separator finger being situated on the separator plate and movable radially thereon in response to rotation of the guide ring to engage and move an optical disc in the stack in a direction at least one of towards and away from the disc holding lip.

2. An optical disc dispenser as defined by claim 1, which further comprises: a base, the base having a circular recess formed in a surface thereof, the guide ring being situated in the circular recess and being rotatable therein, the base having a base opening formed through the thickness thereof, the base opening being situated in alignment with the separator plate opening and being dimensioned to allow an optical disc to pass therethrough.

3. An optical disc dispenser as defined by claim 1, wherein the at least one support gate element includes a first support gate element, a second support gate element, a third support gate element and a fourth support gate element, the first, second, third and fourth support gate elements being circularly arranged end-to-end adjacent one another to define therebetween a gate opening, the first, second, third and fourth support gate elements being operatively coupled to the rotatable guide ring and moving radially in unison between at least a first position and a second position, wherein the first, second, third and fourth support gate elements define the gate opening with a first diameter which is greater than or equal to the diameter of the separator plate opening when the first, second, third and fourth support gate elements are in the first position, and wherein the first, second, third and fourth support gate elements define the gate opening with a second diameter which is less than the diameter of the separate plate opening when the first, second, third and fourth support gate elements are in the second position.

4. An optical disc dispenser as defined by claim 1, wherein the at least one support gate element includes a first support gate element and a second support gate element, the first support gate element and the second support gate element being disposed on diametrically opposite sides of the separator plate opening and defining therebetween a space, the first support gate element and the second support gate element being operatively coupled to the rotatable guide ring and moving radially in unison between at least a first position and a second position, wherein the first support gate element and the second support gate element define the space therebetween with a first dimension which is greater than or equal to the diameter of the separator plate opening when the first support gate element and the second support gate element are in the first position, and wherein the first support gate element and the second support gate element define the space therebetween with a second dimension which is less than the diameter of the separator plate opening when the first support gate element and the second support gate element are in the second position.

5. An optical disc dispenser as defined by claim 1, wherein the at least one separator finger includes an eject separator finger and an insert separator finger, each of the eject separator finger and the insert separator finger being movable radially on the separator plate in response to rotation of the guide ring, the eject separator finger and the insert separator finger being situated relative to one another on diametrically opposite sides of the separator plate opening, the eject separator finger being engageable with and moving an optical disc in the stack in a direction towards the disc holding lip, the insert separator finger being engageable with and moving an optical disc in the stack in a direction away from the disc holding lip.

6. An optical disc dispenser as defined by claim 1, wherein the at least one separator finger includes an elongated body having a lower surface, and a pin extending outwardly from the lower surface of the elongated body; wherein the separator plate includes an upper surface having at least one recessed track formed therein, the at least one recessed track extending radially with respect to the separator plate opening, the at least one recessed track receiving the elongated body of the at least one separator finger; and wherein the guide ring includes an upper surface having at least one separator finger cutout formed therein, the at least one separator finger cutout receiving the pin of the at least one separator finger and causing the at least one separator finger to move reciprocatingly within the at least one recessed track on the separator plate in response to rotation of the guide ring.

7. An optical disc dispenser as defined by claim 6, wherein the at least one separator finger cutout includes a first segment disposed radially inwardly of the guide ring, a second segment disposed radially outwardly of the guide ring and an intermediate third segment extending between and in communication with the first segment and the second segment; and wherein the pin of the at least one separator finger moves in the at least one separator finger cutout of the guide ring between the first segment and the second segment and through the third segment in response to rotation of the guide plate.

8. An optical disc dispenser as defined by claim 1, wherein the at least one support gate element includes a generally planar main body having a lower surface, and a pin extending outwardly from the lower surface thereof; and wherein the guide ring includes an upper surface and at least one support gate element cutout formed in the upper surface thereof, the at least one support gate element cutout receiving the pin of the at least one support gate element, the pin of the at least one support gate element being movable within the at least one support gate element cutout formed in the guide ring in response to rotation of the guide ring.

9. An optical disc dispenser as defined by claim 8, wherein the at least one support gate element cutout formed in the guide ring includes a first segment disposed radially outwardly of the guide ring, a second segment disposed radially inwardly of the guide ring and a third segment extending between and being in communication with the first segment and the second segment, the pin of the at least one support gate element being movable in the at least one support gate element cutout between the first segment and the second segment and through the third segment in response to rotation of the guide ring.

10. An optical disc dispenser as defined by claim 9, which further comprises:
a base, the base having a circular recess formed in a surface thereof, the guide ring being situated in the circular recess and being rotatable therein, the base having a base opening formed through the thickness thereof, the base opening being situated in alignment with the separator plate opening and having a predetermined diameter to allow an optical disc to pass therethrough, the base further having at least one cutout formed in the surface thereof and situated in the circular recess, the at least one cutout extending radially with respect to the base opening, the at least one cutout receiving the pin of the at least one support gate element, the pin of the at least one support gate element being reciprocatingly movable in the radially disposed cutout formed in the base in response to rotation of the guide ring.

11. An optical disc dispenser as defined by claim 1, which further comprises:
a sensor flag, the sensor flag being operatively linked to the guide ring and being rotatable therewith; and
means for limiting the rotation of the guide ring, the guide ring rotation limiting means cooperating with the sensor flag to limit the rotation of the guide ring.

12. An optical disc dispenser as defined by claim 11, wherein the sensor flag is affixed to the guide ring and rotatable therewith; and wherein the guide ring rotation limiting means includes a first optical sensor and a second optical sensor, the first optical sensor and the second optical sensor being disposed in proximity to the guide ring and sensor flag.
